(19) United States
(12) Patent Application Publication
(10) Pub. No.: US 2011/0283206 A1
(43) Pub. Date: Nov. 17, 2011

(54) INTERACTIVE SPLIT FEATURE VISUALIZATION

(75) Inventor: STEVEN M. BROWN, Oslo (NO)

(73) Assignee: SCHLUMBERGER TECHNOLOGY CORPORATION, HOUSTON, TX (US)

(21) Appl. No.: 12/786,592

(22) Filed: May 25, 2010

Related U.S. Application Data
(60) Provisional application No. 61/334,190, filed on May 13, 2010.

(51) Int. Cl. G06F 3/048

(52) U.S. Cl. 715/763

(57) ABSTRACT

Implementations of interactive split feature visualization are described. In one technique described herein, a user interacts with a computer generated model and performs an activation maneuver indicating interest in a feature represented within the model. Based on the activation maneuver, a presentation space is created in the model along a line of the feature. In one implementation the presentation space is formed by moving one or more portions of the model relative to each other, such that nothing in the model is obscured by the presentation space. Data associated with the feature can be displayed within the presentation space.

### RELATED APPLICATIONS

This application claims the benefit of a related U.S. Provisional Application Ser. No. 61/334,190, filed May 13, 2010, entitled “Interactive Split Feature Visualization”, to Brown, the disclosure of which is incorporated by reference herein in its entirety.

### BACKGROUND

Computers can be used to create a variety of computer generated models, which can be constructed from mere ideas or from information associated with existing objects. For example, information associated with a hydrocarbon reservoir, such as seismic and/or well data, can be collected and used by a computer to create a model of the reservoir and any wells within the reservoir.

Often, users of such models will be interested in various areas within the model and will endeavor to access information regarding a particular feature or point in the model.

### SUMMARY

Implementations of interactive split feature visualization are described. In one possible embodiment, a user interacts with a computer generated model and performs an activation maneuver, which is input to a computer indicating the user's interest in a feature represented within the model. Based on the activation maneuver, a presentation space is created in the model along a line of the feature. In one implementation the presentation space is formed by moving one or more portions of the model relative to each other, such that nothing in the model is obscured by the presentation space. Data associated with the feature can be displayed within the presentation space.

This summary is provided to introduce a selection of concepts that are further described below in the detailed description. This summary is not intended to identify key or essential features of the claimed subject matter, nor is it intended to be used as an aid in determining the scope of the claimed subject matter.

### BRIEF DESCRIPTION OF THE CONTENTS

The detailed description is described with reference to the accompanying figures. In the figures, the left-most digit of a reference number identifies the figure in which the reference number first appears. The use of the same reference numbers in different figures indicates similar or identical items.

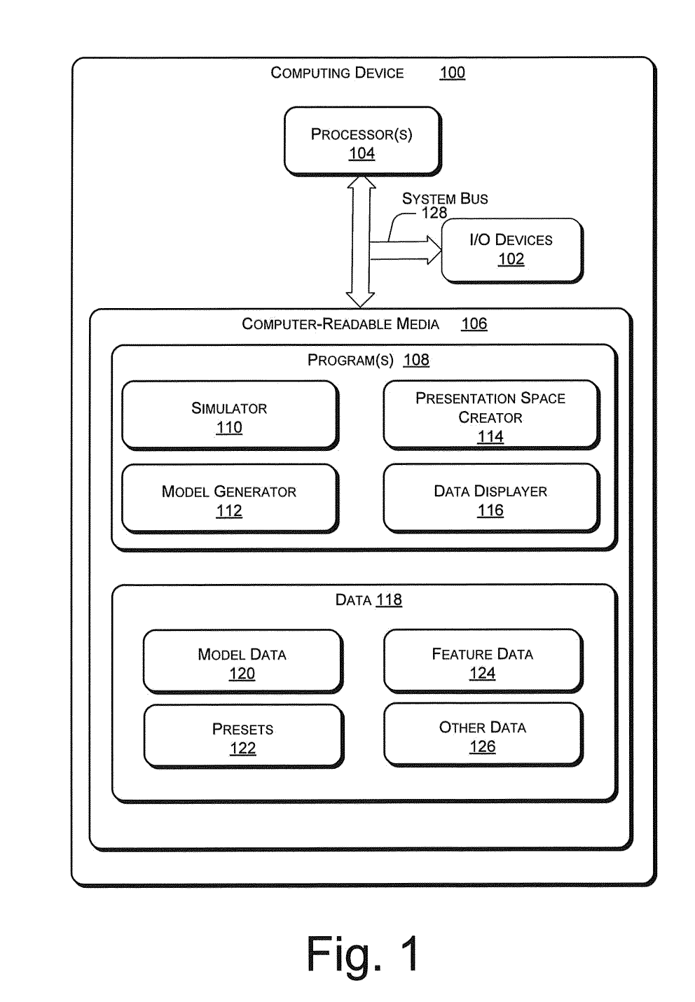

FIG. 1 illustrates an example computing device on which elements of interactive split feature visualization can be implemented.

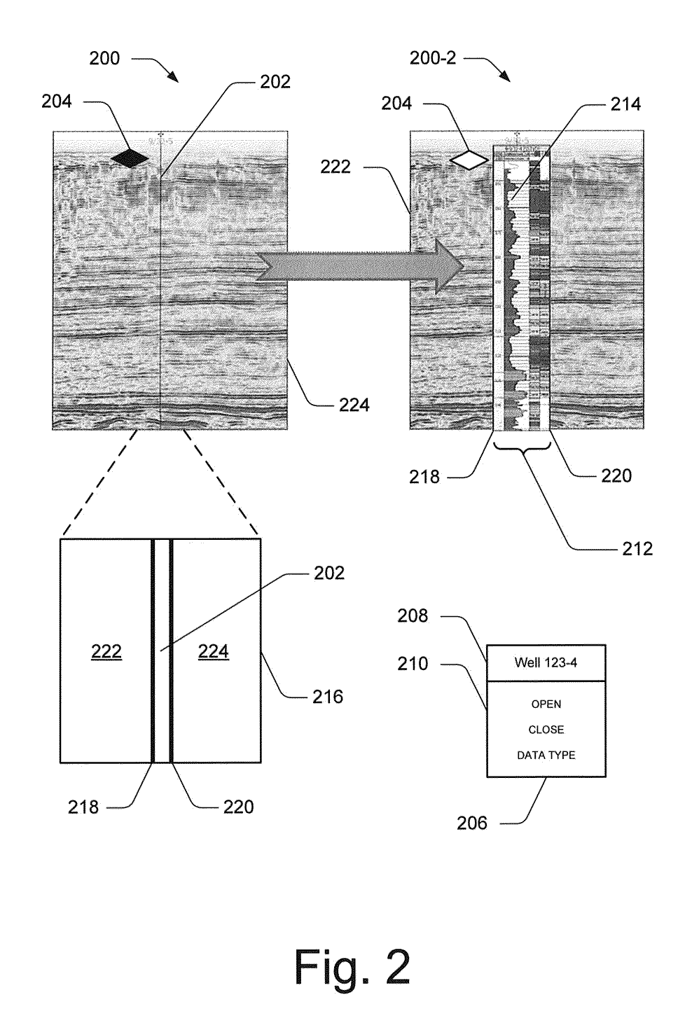

FIG. 2 illustrates example computer generated models in accordance with one embodiment of interactive split feature visualization.

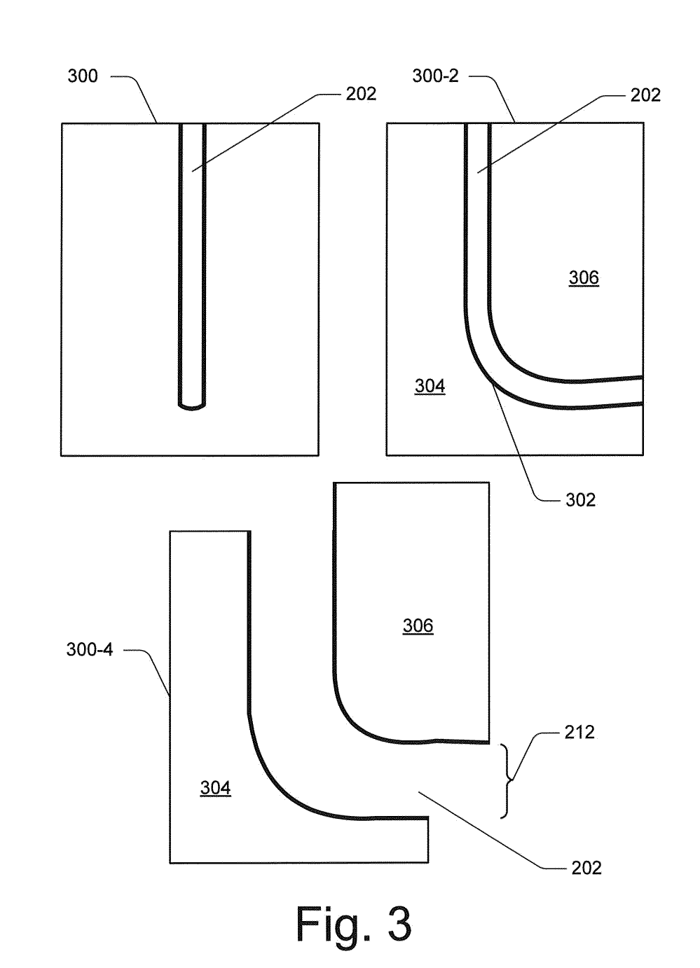

FIG. 3 illustrates example computer generated models generated in accordance with another embodiment of interactive split feature visualization.

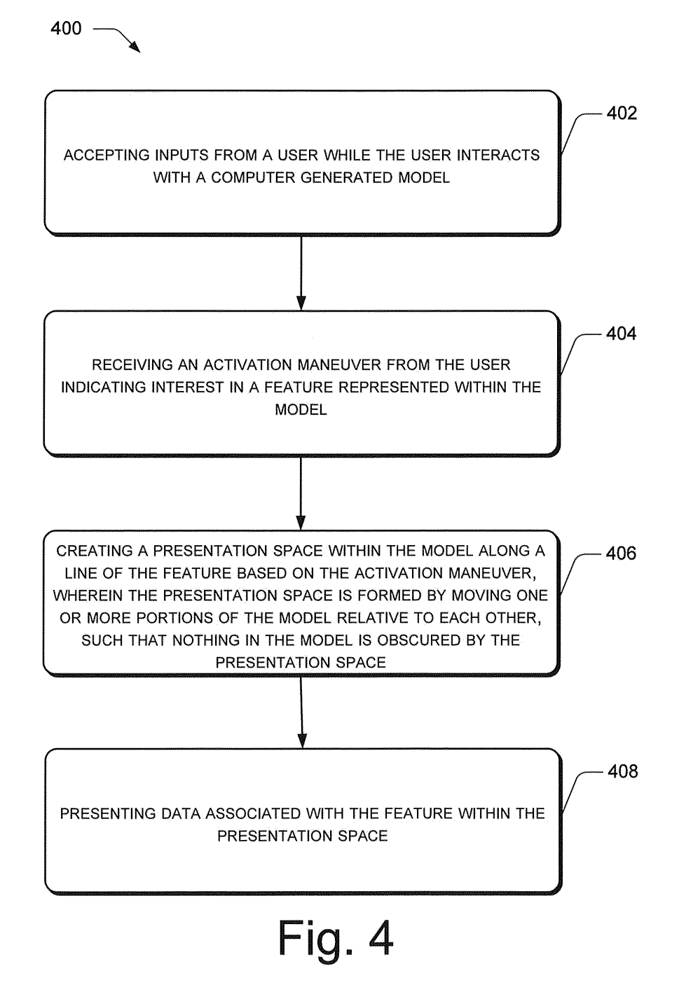

FIG. 4 illustrates example method(s) of interactive split feature visualization.

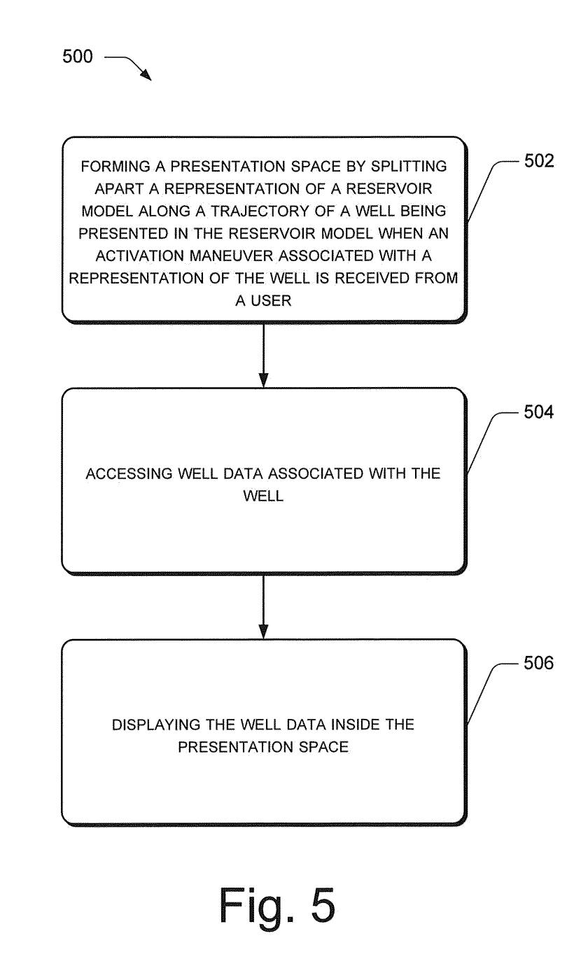

FIG. 5 illustrates example method(s) of interactive split feature visualization.

### DETAILED DESCRIPTION

This disclosure is directed to techniques for implementing interactive split feature visualization. More particularly, the techniques described herein allow a user to interact with a computer generated model and receive data associated with a feature of the model without obscuring either the feature or other portions of the model.

For example, in one possible implementation a user can interact with a representation of a well in a reservoir model by clicking the representation of the well or hovering a cursor on or near the representation of the well. Similarly the user can interact with icon associated with the well, including a drop down menu. Such interactions can be received as an activation maneuver and result in the creation of a presentation space in which various data associated with the well can be displayed. In one possible implementation the presentation space can be created by splitting the reservoir model along an axis defined by the representation of the well, such that none of the information in the reservoir model is obscured by the presentation space or the data displayed in the presentation space.

The user can similarly interact with other wells in the reservoir model such that a plurality of presentation spaces can be opened displaying well data for the other wells.

When the user is finished looking at data associated with a feature he can perform a deactivation maneuver similar to the activation maneuvers discussed above, thereby closing up the presentation space, and returning the model to its original state in which neither the presentation space nor the data are displayed.

### Example Environment

FIG. 1 shows an example computing device 100 suitable for implementing embodiments of interactive split feature visualization. Computing device 100 can be implemented as any form of computing and/or electronic device. For example, computing device 100 can include a server, a desktop PC, a notebook or portable computer, a workstation, a mainframe computer, an Internet appliance and so on. Computing device 100 can include input/output (I/O) devices 102, one or more processor(s) 104, and computer-readable media 106.

I/O devices 102 can include any device over which data and/or instructions can be transmitted or received by computing device 100. For example, I/O devices 102 can include one or more of an optical disk drive, a USB device, a keyboard, a touch screen, a monitor, a mouse, a digitizer, a scanner, a track ball, etc.

I/O devices 102 can also include one or more communication interface(s) implemented as any of one or more of a serial and/or parallel interface, a wireless interface, any type of network interface, a modem, a network interface card, or any other type of communication interface capable of connecting computing device 100 to a network or to another computing or electrical device.

Processor(s) 104 include microprocessors, controllers, and the like configured to process various computer executable instructions controlling the operation of computing device 100. For example, processor(s) 104 can enable computing device 100 to communicate with other electronic and computing devices, and to process instructions and data in conjunction with programs 108 stored in computer-readable media 106.

Computer-readable media 106, can include one or more memory components including random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), a DVD, a DVD+RW, and the like.

Computer-readable media 106 provides storage mechanisms to store various information and/or data such as software applications and any other types of information and data related to operational aspects of computing device 100. For example, programs 108 stored on computer-readable media 106 can include a simulator 110, a model generator 112, a presentation space creator 114, a data displayer 116, and other programs—such as an operating system and/or assorted application programs. Programs 108 can be executed on processor(s) 104.

Computer-readable media 106 can also include data 118. For example, as illustrated in FIG. 1, data 118 residing on computer-readable media 106 can include model data 120, presets 122, feature data 124, and other data 126 (including intermediate and final data created through use of one or more of programs 108).

Any of programs 108 and data 118 can reside wholly or partially on any of a variety of media types found in computer-readable media 106. For example, portions of presentation space creator 114 can reside at different times in random access memory (RAM), read only memory (ROM), optical storage discs (such as CDs and DVDs), floppy disks, optical devices, flash devices, etc.

A system bus 128 can couple one or more of the processor(s) 104, I/O devices 102 and computer-readable media 106 to each other. System bus 128 can include one or more of any of several types of bus structures, including a memory bus or memory controller, a peripheral bus, an accelerated graphics port, and a processor or local bus using any of a variety of bus architectures. By way of example, such architectures can include an industry standard architecture (ISA) bus, a micro channel architecture (MCA) bus, an enhanced ISA (EISA) bus, a video electronics standards association (VESA) local bus, and a peripheral component interconnects (PCI) bus also known as a mezzanine bus, and so on.

### Example Presentation Space

FIG. 2 illustrates an example computer generated model 200 in which embodiments of interactive split feature visualization can be practiced. As shown, model 200 is a reservoir simulation model, though it will be understood that interactive split feature visualization can be used with any computer generated model known in the art.

Model 200 can include one or more representations 202 of a variety of features. For example, in one possible implementation a feature being represented by representation 202 can include a well. In other implementations, a feature represented by representation 202 can include a welded seam, an interface between two or more parts, a protrusion, an imperfection, and so on.

Representation 202 can have associated with it a variety of data of interest, which might be cumbersome if is all presented within model 200. Such data can include information associated with various points along representation 202.

For the sake of illustration, and not limitation, if representation 202 corresponds to a well, the variety of specific data that can be associated with representation 202 includes depth dependent data gathered through the use of a variety of tools placed into the well, along with other data including seismic data, production data, and any other information known in the art associated with the well.

A user interested in seeing some or all of the data associated with the feature represented by representation 202 can register such interest by interacting with representation 202 and effecting an activation maneuver. Example activation maneuvers include a user floating a cursor over representation 202 or placing a cursor within a given distance of representation 202. Such a distance can be preset (and saved, for example, in presets 122) or it can vary automatically given factors such as a size of representation 202, a density of features and/or other representations 202 in a given area of model 200, etc.

The user can also register an activation maneuver by clicking on or near representation 202, or by interacting with an icon 204 associated with representation 202. Icon 204 can include any representation known in the art, including a drop down menu 206, and can be located within model 200 or outside of it.

For instance, icon 204 associated with representation 202 can be positioned proximate to representation 202 making it clear that icon 204 is associated with representation 202. Alternately, in another possible embodiment, a label including information associated with the feature represented by representation 202, such as label 208, can be associated with icon 204. If desired, icon 204 can be placed in an area of model 200 such that nothing of great interest in model 200 is obscured by its presence.

Alternately, icon 204 can be placed outside of model 200. For example, icon 204 can be placed proximate to feature 202 but outside of model 200. Similarly, icon 204 can be placed anywhere else outside of model 200, such as in a side bar, and be associated with representation 202 through a variety of means, including a label, such as label 208.

In one implementation, once a user interacts with icon 204—either by clicking icon 204, or floating a cursor on or over icon 204—a drop down menu 210 will be displayed. Drop down menu 210 can give the user a variety of options, including opening and closing a presentation space. Menu 210 can also include options allowing the user to choose what kinds of data will be displayed in a presentation space.

It will be understood that more than one icon 204 can be associated with representation 202. In such case, the plurality of icons 204 associated with representation 202 can be found in any combination inside and outside of model 200. Moreover, in one possible implementation even when one or more icons 204 are used as described above, the user may also be able to submit activation maneuvers using the aforementioned techniques of interacting with representation 202 directly or indirectly through use of a cursor.

It will also be understood that a plurality of features presented in model 200 may be available for interaction. In such a case the user may be able to interact with representations 202 associated with these features using any of the techniques described above, including any conceivable combination of the techniques described above.

### Presentation Space Creation

Once an activation maneuver is registered, a presentation space 212 can be created and data 214 associated with feature 202 can be represented in presentation space 212. In one possible implementation, an activation maneuver results in the automatic creation of presentation space 212 such that presentation space 212 obscures none of the information being presented in model 200.

For example, in one possible embodiment presentation space 212 can be created by splitting model 200 along a trajectory of representation 202. For instance, as shown in blown up sub block 216 of model 200, representation 202 can be seen as having opposing sides 218, 220. In the event representation 202 corresponds to a well, opposing sides 218, 220 can include opposing sides of the well's bore.

Correspondingly, model 200 can be seen as having sides 222, 224 on either side of representation 202. Therefore, by moving one or more of sides 222, 224 of model 200 relative to one another, and away from an axis defined by the trajectory of feature 202, model 200 can be altered such that a void is created between sides 222 and 224. In such a manner, the integrity of model 200 and sides 222 and 224 is maintained, with all of the information in sides 222 and 224 still being displayed in newly formed model 202-2.

Stated another way, the void, or presentation space 212 created, is independent of model 200 and will obscure none of the information presented in model 200. Instead, presentation space 212 is formed independently of model 200 and includes free space in which data 214 associated with the feature being represented by representation 202 can be placed. The result is an updated model 202-2 which displays all of the information displayed in model 200 (including all of the information displayed in sides 222, 224) as well as newly presented data 214 associated with representation 202.

In one possible embodiment, once presentation space 212 is created, the user can interact with presentation space 212 to determine its size and/or a type of data to be displayed in data 214. Alternately, a size of presentation space 212 can be preset or determined automatically using factors such as, but not limited to, a type of data 214 to be displayed in presentation space 212, an amount of data 214 to be presented in presentation space 212, a size of the feature being represented by representation 202, an amount of display area left on a display on which model 200 is being displayed, a density of features in model 200, and/or a density of features or information within a given distance of representation 202.

In one implementation, even if presentation space 212 is determined automatically, a user may still be allowed to interact with presentation space 212 and alter a size and/or appearance of presentation space 212.

Similarly, once data 214 is displayed (by whatever method—automatic or manual) a user may be allowed to interact with data 214 and alter a size and/or appearance of data 214. This includes allowing a user to alter a type of data being displayed in data 214.

### Customizing Model

FIG. 3 illustrates further examples of computer generated models 300, 300-2, 300-4, which can be generated using other embodiments of interactive split feature visualization.

For example, in model 300 a feature represented by representation 202 can include one or more bends 302. If representation 202 is shown in a front view, such as in model 300, bend(s) 302 may not be evident. However, when the feature is shown from other perspectives, such as in models 300-2 and 300-4, bend 302 in the trajectory of the feature can be more clearly seen.

Therefore it is often useful for a user to interact with model 300 and/or representation 202 to alter a perspective or orientation of representation 202. For example, a user may input information, through a keyboard or other input devices (including interacting directly with model 300 and/or representation 202) and request that model 300 and/or representation 202 be rotated a certain number of degrees. It will be understood that any number of degrees may be input by a user. Furthermore it will be understood that a variety of other operations on model 300 and/or representation 202 can be effected by a user, resulting in a presentation of model 300 and/or representation 202 in any orientation possible in three space.

In one implementation, the rotation desired may be set at 90 degrees and result in representation 202 being displayed as shown in model 300-2. Once a user is satisfied with the orientation of representation 202, the user may effect an activation maneuver using one or more of the various techniques described above (in any possible combination) to result in the creation of presentation space 212, such as is shown in model 300-4.

In one implementation, presentation space 212 in 300-4 can be created by moving one or more of sides 304, 306 of model 300-2 on either side of representation 202 relative to one another such that all of the information displayed in sides 304, 306 in model 300-2 is still represented in sides 304, 306 in model 300-4.

In one embodiment, a size of presentation space 212, as well as a size, orientation, and type of data 214 displayed in presentation space 212 can be determined by a user using the various methods described above.

In one possible implementation, data 214 presented in presentation space 212 can follow a trajectory or contour of representation 202 such that no information displayed in either side 304, 306 of model 300-2 is obscured in model 300-4.

### Closing a Presentation Space

In one implementation, existing presentation spaces 212 and data 214 can be closed when the user performs a deactivation maneuver. Deactivation maneuvers include any of the activation maneuvers described above. Furthermore, a deactivation maneuver different from the activation maneuver used to open a particular presentation space 212 may be used.

For example, if a user created a presentation space 212 by clicking on a representation 202, a user could then close presentation space 212 by clicking on representation 202 or by interacting with an icon 204 associated with representation 202 (including a special icon displayed after the creation of presentation space 212 and/or data 214).

Moreover, in some embodiments, presentation space 212 and/or data 214 will remain extant only if an activation maneuver is maintained. For example, in one possible implementation presentation space 212 and/or data 214 can be displayed only as long as a cursor hovers on or near representation 202. Once the cursor is removed, presentation space 212 and 214 are closed.

Closing presentation space 212 and/or data 214 will be understood to mean removing presentation space 212 and/or data 214 from a model. For example, when presentation space 212 and/or data 214 are closed in model 200-2, the result is a return to model 200.

### EXAMPLE METHODS

FIGS. 4-5 illustrate example methods for implementing aspects of interactive split feature visualization. The methods are illustrated as a collection of blocks in a logical flow graph representing a sequence of operations that can be implemented in hardware, software, firmware, various logic or any combination thereof. The order in which the methods are described is not intended to be construed as a limitation, and any number of the described method blocks can be combined in any order to implement the methods, or alternate methods. Additionally, individual blocks may be deleted from the methods without departing from the spirit and scope of the subject matter described therein. In the context of software, the blocks can represent computer instructions that, when executed by one or more processors, perform the recited operations. Moreover, for discussion purposes, and not purposes of limitation, selected aspects of the methods may described with reference to elements shown in FIGS. 1-3.

### Example Method I

FIG. 4 illustrates an example method 400 for implementing interactive split feature visualization. At block 402, inputs are accepted from a user while the user interacts with a computer generated model. For example, in one implementation the user can be interacting with a model such as model 200. Interactions can include any interaction known in the art, including changing an orientation of the model and/or a representation of a feature in the model, such as representation 202, such that the feature or model is displayed more clearly to the user.

At block 404, an activation maneuver can be received from the user indicating the user's interest in a feature represented in the model. Activation maneuvers can include a variety of actions and combinations thereof including, but not limited to, clicking the representation, moving a cursor over or near to the representation, or interacting with an icon, such as icon 204, associated with the feature. In one implementation, the icon can include a drop down menu, such as drop down menu 206.

At block 406, a presentation space, such as presentation space 212, is created within the model based on the activation maneuver. The presentation space is created along a line or trajectory of the feature, and can be formed by moving one or more portions of the model, such as sides 222, 224 or sides 304, 306 relative to each other, such that nothing in the model, or its sides, is obscured by the newly formed presentation space.

In one possible implementation, a size and orientation of the presentation space can be determined by a user using any method known in the art, including grabbing portions of the presentation space, such as corners, and dragging them.

At block 408, data, such as data 214, is presented in the presentation space. The data can include any data associated with the feature represented in the model and can be presented in a location specific manner. For example, if the feature represented is a well, the data represented in the presentation space associated with the representation of the well can include depth dependent well data, seismic data, and any other related well data known in the art. Data for a given location of the well can be placed at or near the location.

In one possible implementation, a size and orientation of the data can be determined by a user using any method known in the art, including grabbing portions of the data, and dragging them. Furthermore, types of data presented can also be customized by the user

### Example Method II

FIG. 5 illustrates another example method 500 for implementing interactive split feature visualization. At block 502 a presentation space, such as presentation space 212, is created by splitting a reservoir model, such as reservoir models 200, 300. In one implementation this split can be done along a trajectory of a well represented in the model. In one embodiment the creation of the presentation space can be effected by a user's interaction with a representation, such as representation 202 in FIG. 2 and/or FIG. 3, of the well. In another implementation, the creation of presentation space can be effected by user interaction with an icon, such as icon 204, associated with the representation of the well. In either event, interactions with the representation or an icon which result in a presentation space being created can be termed activation maneuvers.

In one possible embodiment, all of the information being displayed in the model previous to the existence of the presentation space is still displayed clearly in the model after creation of the presentation space. Users may or may not be able to change the size, location and orientation of the presentation space within the reservoir model.

At block 504, well data associated with the well is accessed. The well data can include any data which might be associated with a well including, but not limited to, depth dependent data, seismic data, and production data.

At block 506, some or all of the well data is presented in the presentation space. The well data can be presented such that it stays entirely within the presentation space and therefore does not obscure any of the information being presented in the reservoir model. Well data can be location specific (i.e. it can be presented at or near points of the well to which it corresponds) and in one implementation, the user can interact with the data to determine what kinds of data are displayed, as well as how they are displayed.

### CONCLUSION

Although embodiments of interactive split feature visualization have been described in language specific to structural features and/or methods, it is to be understood that the subject of the appended claims is not necessarily limited to the specific features or methods described. Rather, the specific features and methods are disclosed as example implementations of interactive split feature visualization.

What is claimed is:

1. A method of allowing a user to interact with a representation of a well in a computer generated reservoir model comprising:
receiving an activation maneuver from the user indicating interest in the well;
splitting apart the reservoir model along a trajectory of the well forming a presentation space, while preserving an integrity of the reservoir model; and
presenting well data associated with the well within the presentation space.

2. The method of claim 1, wherein receiving includes one or more of:
registering that a cursor is within a preset distance of the representation of the well;
registering a cursor click made a preset distance from the representation of the well;
registering interaction with an icon associated with the well.

3. The method of claim 1, wherein splitting apart includes moving one or more of first and second sides of the reservoir model on either side of the trajectory of the well relative to one another such that a presentation space is created large enough to present the well data without obscuring any part of the first and second sides of the reservoir model and without obscuring any part of the representation of the well.

4. The method of claim 1, wherein presenting comprises including a representation of well data in the presentation space such that the representation of well data does not obscure any features of the reservoir model and the representation of well data does not obscure any features of the representation of the well.

5. The method of claim 1, further comprising:
receiving inputs from the user and changing a presentation of the well data in the presentation space based on the inputs.

6. The method of claim 1, further comprising:
changing an orientation of the representation of the well in response to user inputs.

7. The method of claim 1, further comprising:
receiving a deactivation maneuver from the user and based on the deactivation maneuver removing the presentation space and well data from a representation of the reservoir model.

8. A computer-readable medium having a set of computer-readable instructions residing thereon that, when executed, direct a processor to initiate acts comprising:
forming a presentation space by splitting apart a representation of a reservoir model along a trajectory of a well being presented in the reservoir model when an activation maneuver associated with a representation of the well is received from a user;
accessing well data associated with the well;
displaying the well data inside the presentation space.

9. The computer-readable medium of claim 8 having a set of computer-readable instructions that, when executed, perform acts further comprising:
altering the well data being displayed in the presentation space in accordance with inputs received from the user.

10. The computer-readable medium of claim 8 having a set of computer-readable instructions that, when executed, perform acts further comprising:
displaying at least some of the well data proximate to portions of the well with which the well data is associated.

11. The computer-readable medium of claim 8 having a set of computer-readable instructions that, when executed, perform acts further comprising:
interpreting that the activation maneuver has been input by the user when a position of a cursor comes within a preset distance from the representation of the well.

12. The computer-readable medium of claim 8 having a set of computer-readable instructions that, when executed, perform acts further comprising:
interpreting that the activation maneuver has been input by the user when the user interacts with an icon associated with the well.

13. The computer-readable medium of claim 8 having a set of computer-readable instructions that, when executed, perform acts further comprising:
removing the presentation space and well data, and undoing the splitting apart of the representation of the reservoir model when a deactivation maneuver is received.

14. The computer-readable medium of claim 13 having a set of computer-readable instructions that, when executed, perform acts further comprising:
interpreting a movement wherein a cursor moves outside a preset distance from the representation of the well as the deactivation maneuver.

15. The computer-readable medium of claim 13 having a set of computer-readable instructions that, when executed, perform acts further comprising:
interpreting an interaction with an icon associated with the well as the deactivation maneuver.

16. A method comprising:
accepting inputs from a user while the user interacts with a computer generated model;
receiving an activation maneuver from the user indicating interest in a feature represented within the model;
creating a presentation space within the model along a line of the feature based on the activation maneuver, wherein the presentation space is formed by moving one or more portions of the model relative to each other, such that nothing in the model is obscured by the presentation space; and
presenting data associated with the feature within the presentation space.

17. The method of claim 16, wherein accepting includes accepting inputs from a user interacting with a well represented in a reservoir model.

18. The method of claim 16, wherein receiving includes receiving user one or more user interactions with an icon associated with the feature.

19. The method of claim 18, further comprising:
altering how the feature is displayed in the model based on inputs from the user.

20. The method of claim 16, further comprising:
receiving a second activation maneuver from the user indicating interest in a second feature represented within the model;
creating a second presentation space within the model along a line of the second feature based on the second activation maneuver, wherein the second presentation space is formed by moving one or more portions of the model relative to each other such that nothing in the model is obscured by the second presentation space; and
presenting data associated with the second feature within the second presentation space.
